(19) United States
(12) Patent Application Publication
(10) Pub. No.: US 2005/0072418 A1
(43) Pub. Date: Apr. 7, 2005

(54) Deep fat fryer with interior baffle and exhaust deflector

(76) Inventor: Michael J. McGowan, Shreveport, LA (US)

Correspondence Address: John M. Harrison, 2139 E. Bert Kouns, Shreveport, LA, 71105, US

(21) Appl. No.: 10/784,682

(22) Filed: Feb. 23, 2004

Related U.S. Application Data
(60) Provisional application No. 60/449,175, filed on Feb. 24, 2003.

(51) Int. Cl. A47J 27/026

(52) U.S. Cl. 126/391.1; 99/403

(57) ABSTRACT

A deep fat fryer which includes a housing fitted with a bottom burner and having a cooker characterized by a tank seated in the housing with a reservoir for containing a quantity of cooking oil. The tank includes a reverse-curve baffle that separates the oil reservoir from the burner chamber and an exhaust deflector is provided at the top of the tank to deflect the burner exhaust fumes and products of combustion. Basket support rods extend from the reverse-curve baffle to the side of the tank to support a wire basket containing food to be cooked in oil provided in the oil reservoir and heated by the burner. In a preferred embodiment of the invention the cooker and tank are seated on a support and the cooker may be removed from the housing to expose the burner and a burner frame mounting the burner may also be removed from the housing for replacement or repair. An oil drain is provided in the bottom of the cooker tank and communicates with the reservoir to facilitate draining oil from the tank, and the reverse curvature of the reverse-curve baffle minimizes residue accumulation on the baffle and facilitates the concentration of corn meal and other residue in the bottom of the tank for easy drainage and flushing through the oil drain.

### CROSS-REFERENCE TO RELATED APPLICATIONS

This application claims the benefit of and incorporates by reference prior filed copending U.S. Provisional Application Ser. No. 60/449,175, filed Feb. 24, 2003.

### SUMMARY OF THE INVENTION

This invention relates to deep fat fryers and more particularly, to a combination cooker, housing and support, the cooker having a tank with an oil reservoir for containing cooking oil, wherein the tank is fitted with a reverse-curve baffle that separates the oil reservoir in the tank from a burner chamber housing a burner for heating the oil in the oil reservoir. A pair of basket support rods typically extend from the reverse-curve baffle to the opposite side of the tank for supporting a wire basket containing food to be cooked in the hot oil located in the oil reservoir. The reverse-curve baffle is designed to facilitate sliding of corn meal, food particles and other residue from the baffle surface by gravity and collection of these particles in the bottom of the tank, and drainage of the oil and residue from the reservoir through an oil drain and valve located in the bottom of the tank. Cylindrical thermometer supports are also optionally provided in the tank to facilitate insertion of one or more thermometers into the oil reservoir to monitor the temperature of the cooking oil. The cooker and tank can be placed on any supporting surface for use, or on a specially designed support, as hereinafter described.

### BRIEF DESCRIPTION OF THE DRAWINGS

The invention will be better understood by reference to the accompanying drawings, wherein:

FIG. 1 is a perspective view of a preferred embodiment of the deep fat fryer of this invention, illustrated in functional configuration with the cooker inserted in the housing and a wire basket in functional location partially submerged in the oil reservoir for cooking purposes;

FIG. 2 is a perspective view of the deep fat fryer illustrated in FIG. 1, more particularly illustrating the wire basket lifted from the oil reservoir and seated on a basket mount attached to the cooker tank for draining cooked food (not illustrated) located in the wire basket;

FIG. 3 is an exploded view of the deep fat fryer, including the housing and the cooker illustrated in FIGS. 1 and 2;

FIG. 4 is a sectional view taken along line 4-4 of the deep fat fryer illustrated in FIG. 1, more particularly illustrating the interior of the cooker tank, including the oil reservoir and the burner chamber, which are separated by a reverse-curve baffle and further illustrating the burner positioned beneath the reverse-curve baffle;

FIG. 5 is a top perspective view of the cooker removed from the cooker tank;

FIG. 6 is a bottom perspective view of the cooker illustrated in FIG. 5.

FIG. 7 is a perspective view of the cooker illustrated in FIGS. 1-6 resting on an optional stand or support; and

FIG. 8 is an exploded view of the cooker and support illustrated in FIG. 7.

### DESCRIPTION OF THE PREFERRED EMBODIMENTS

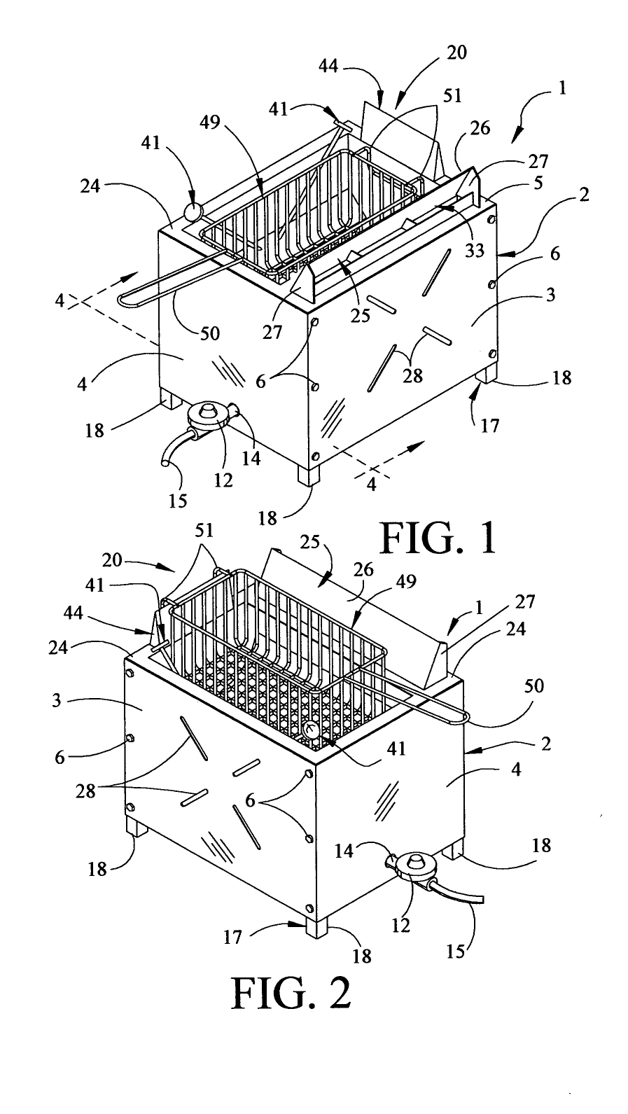

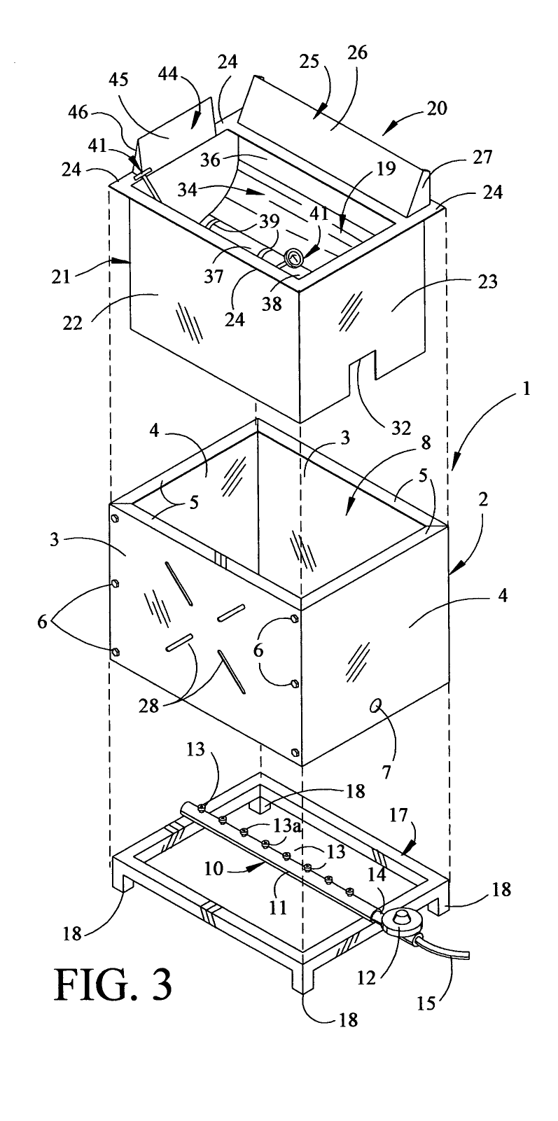

Referring initially to FIGS. 1-3 of the drawings the deep fat fryer of this invention is generally illustrated by reference numeral 1 and includes a rectangular housing 2, defined by a pair of housing side panels 3, connected by housing end panels 4 and fitted with an inwardly-turned housing flange 5 (FIG. 3) at the top edges and perimeter of the housing side panels 3 and the housing end panels 4. Housing fasteners 6 serve to connect the housing side panels 3 to the housing end panels 4 using inwardly-turned tabs (not illustrated) and an opening 7 (FIG. 3) is provided in one of the housing end panels 4 to receive a gas intake line 14 that connects to the burner pipe 11 of a burner 10, seated on a burner frame 17 as further illustrated in FIG. 3 of the drawings. In a preferred embodiment a gas regulator 12 is attached to the gas intake line 14 and a gas supply line 15 connects to a source of natural gas or liquified gas such as butane or propane (not illustrated). The gas supply line 15 supplies gas to the gas regulator 12 and from the gas regulator 12, through the gas intake line 14 to the burner pipe 11 and then to multiple burner nozzles 13, extending upwardly from the burner pipe 11, each fitted with a nozzle orifice 13a. As further illustrated in FIG. 3 of the drawings the housing 2 typically fits on top of the detachable burner frame 17, having optional frame legs 18, and may be attached to the burner frame 17 in any convenient manner.

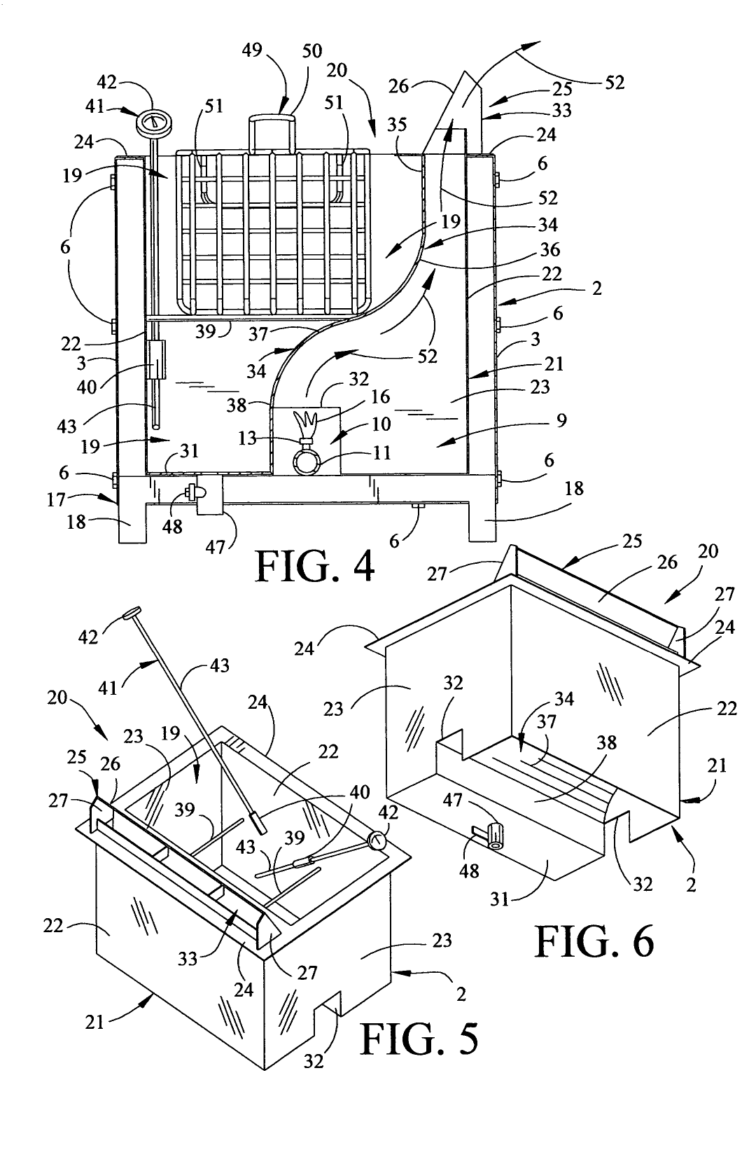

As further illustrated in FIGS. 1-4 a cooker 20 is characterized by a rectangular tank 21 that is undersized to fit in the housing cavity 8 of the housing 2, as illustrated in FIGS. 1-3. As illustrated in FIGS. 3 and 4 the tank 21 includes an oil reservoir 19 that is shaped by a tank side 22 and a reverse-curve baffle 34, as further hereinafter described. The tank 21 is further characterized by spaced-apart tank sides 22 and tank ends 23 and also includes an outwardly-extending tank flange 24 that skirts the top edges and perimeter of the tank sides 22 and the tank ends 23, to seat on the housing flange 5 of the housing 2 when the tank 21 is seated in the housing 2, as illustrated in FIGS. 1 and 2. An exhaust deflector 25 extends from the tank flange 24 along one of the tank sides 22 and includes an outwardly-angled deflector top 26, extending from a baffle top 35 (FIG. 4) and deflector sides 27, to define an exhaust opening 33.

Referring now to FIGS. 4-6 of the drawings the tank 21 of the cooker 20 is further characterized by a flat tank bottom 31 that defines the bottom of the oil reservoir 19 and typically includes an oil drain 47, fitted with a drain valve 48 for draining the contents of the oil reservoir 19. Furthermore, the reverse-curve baffle 34 extends from the tank bottom 31 upwardly to define a straight baffle leg 38 that terminates in a bottom curve 37, extending toward a tank side 22. The bottom curve 37 then curves upwardly to define a reverse top curve 36, having a curvature opposite to that of the bottom curve 37 and the reverse top curve 36 terminates in a straight baffle top 35, as illustrated in FIG. 4. Accordingly, as further illustrated in FIG. 4, the tank 21 includes the oil reservoir 19 and a burner chamber 9 separated by the reverse-curve baffle 34, such that the burner 10 is typically located immediately beneath the bottom curve 37 of the reverse-curve baffle 34 to facilitate heating the reverse-curve baffle 34 and the oil located in the oil reservoir 19 by the flames 16, fired from each respective nozzle orifice 13a in the spaced-apart burner nozzles 13, more particularly illustrated in FIG. 3 of the drawings.

As further illustrated in FIGS. 5 and 6 of the drawings a burner slot 32 typically extends between the tank ends 23 of the tank 21 to accommodate the burner pipe 11 when the deep fat fryer is assembled as illustrated in FIGS. 1 and 2 of the drawings. Air vents 28 are also typically provided in one or both of the side panels 3 of the housing 2 for supplying air to the burner pipe 11. The exhaust opening 33, provided in the exhaust deflector 25 mounted on the tank flange 24 extending along one side of the tank side 22 as further illustrated in FIG. 24, exhausts the exhaust gases represented by the arrows 52 generated by the flames 16 emitting from the respective burner nozzles 13 in the burner 10. Furthermore, the outwardly-angled deflector top 26 serves to deflect these exhaust gases 52 away from the user for added comfort in using the deep fat fryer 1, as further illustrated in FIG. 4 of the drawings. A pair of spaced-apart basket support rods 39 extend from welded or other fixed attachment to the top of the bottom curve 37 in the reverse-curve baffle 34, to like attachment to the opposite tank side 22 of the tank 21. The basket support rods 39 support a wire basket 49, fitted with a basket handle 50 and a downwardly-extending basket support 51, under circumstances where the bottom of the basket 49 and the enclosed food (not illustrated) are immersed in cooking oil (not illustrated) located in the oil reservoir 19. The basket 49 can be lifted from the oil reservoir 19 and the contents drained of excess cooking oil by engaging the basket support 51 with an optional basket mount 44, typically attached to one of the tanks ends 23 of the tank 21 as illustrated in FIGS. 1-3 of the drawings. The basket mount 44 may be omitted from the tank 21, as illustrated in FIGS. 4-6, and when used, is typically characterized by a mount plate 45 fitted with plate gussets 46, that are welded or otherwise secured to the corresponding tank flange 24 of the corresponding tank side 22, as illustrated in FIG. 3 of the drawings.

As further illustrated in FIGS. 4 and 5 of the drawings one or more thermometers 41, each characterized by a thermometer dial 42 at the top end and an extending thermometer leg 43, are seated in corresponding cylindrical thermometer supports 40, that are welded or otherwise attached to the tank side 22 opposite the reverse curve baffle 34. The thermometers 41 can thus be extended into the cylindrical thermometer supports 40 with the thermometer leg 43 immersed in a supply of cooking oil (not illustrated) provided in the oil reservoir 19 to monitor the temperature of the oil during the cooking process.

It will be appreciated by those skilled in the art from a consideration of FIG. 4 of the drawings, that a primary function of the reverse-curve baffle 34 is not only to separate the burner chamber 9 from the oil reservoir 19, but also to provide an efficient heating area along the top curve 36 and the bottom curve 37 for efficiently heating the cooking oil in the oil reservoir 19. Moreover, the curvature of the bottom curve 37 allows corn meal, food residue and other residue in the oil reservoir 19 to slide from the reverse-curve baffle 34 by gravity and accumulate at the tank bottom 31, as the residue will not easily adhere to the smooth bottom curve 37. This facilitates quick and easy drainage of the oil and residue in the oil reservoir 19 through the oil drain 47 by operation of the drain valve 48. Another function of the reverse-curve baffle 34 is to define the shape of the burner chamber 9, which is wide at the bottom end to accommodate the burner 10 and narrow at the top, between the baffle top 35 and the upper tank side 22 of the tank 21, to cause optimum channeling of the products of combustion from the burner nozzles 13 upwardly through the exhaust deflector 25, as indicated by the exhaust gas arrows 52. Furthermore, the deflector top 26 of the exhaust deflector 25 is so shaped and angled that it deflects the exhaust gases 52 outwardly, away from a user of the deep fat fryer 1, thus greatly increasing the comfort level of use.

Another advantage of the deep fat fryer of this invention is the facility for resting the basket 49 on the parallel, spaced-apart basket support rods 39 during cooking. In a preferred embodiment a pair of these basket support rods 39 is provided as illustrated in FIG. 5, although additional basket support rods 39 can be used if so desired, depending upon the size of the basket 49 and the tank 21.

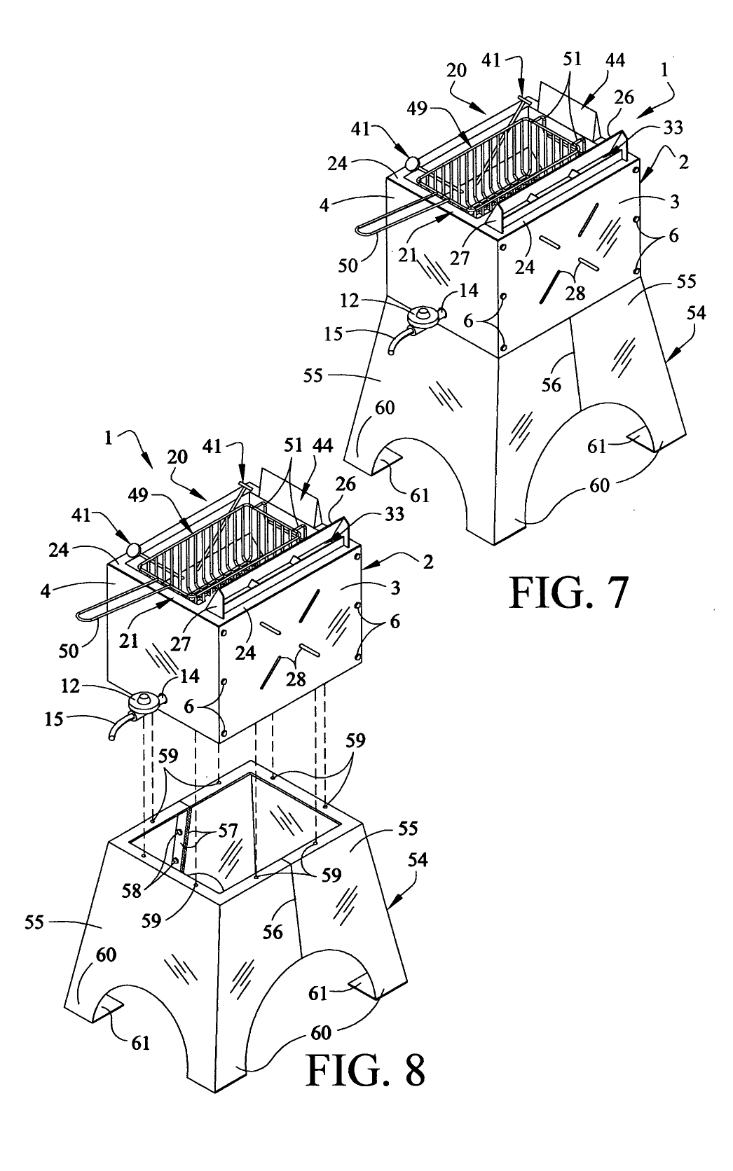

Referring now to FIGS. 7 and 8 of the drawings in another preferred embodiment of the invention the deep fat fryer 1 includes a fryer stand or support 54 for elevating the cooker 20 and the tank 21 to a comfortable position for use. In a preferred embodiment the fryer support 54 is characterized by a pair of support frames 55 that are joined along a match line 56 by engaging corresponding match line flanges 57 and connecting the match line flanges 57 with metal screws 58. Metal screw openings 59 are typically provided in the top support flanges 62, provided in the support frames 55, for attaching the housing 2 to the support frames 55 using additional metal screws (not illustrated). Alternatively, the housing 2, typically without the frame legs 18, can be seated on the fryer support 54 without using the metal screws 58 for attachment purposes, as desired. The fryer support 54 is further characterized by support legs 60 that extend downwardly in each of the support frames 55 and in a preferred embodiment, include leg plates 61 projecting inwardly, for stabilizing the fryer support 54. Accordingly, it will be appreciated from a consideration of the drawings that the deep fat fryer 1 can be utilized with the fryer support 54 illustrated in FIGS. 7 and 8, or it may be placed on a workbench, table or the like, to enhance portability, without the use of the fryer support 54, as desired.

While the preferred embodiments of the invention have been described above, it will be recognized and understood that various modifications may be made in the invention and the appended claims are intended to cover all such modifications which may fall within the spirit and scope of the invention.

1. A deep fat fryer comprising a housing; a tank adapted for seating in said housing and a reservoir provided in said tank for containing cooking oil; a burner chamber provided in said tank adjacent to said reservoir; a gas burner provided in said burner chamber for heating the cooking oil in said reservoir; an exhaust opening provided in said tank for exhausting the products of combustion from said gas burner; and a reverse-curve baffle provided in said tank, said reverse-curve baffle separating said reservoir from said burner chamber.

2. The deep fat fryer of claim 1 comprising an exhaust deflector provided on said tank at said exhaust opening for deflecting the products of combustion from said gas burner away from said tank and said housing.

3. The deep fat fryer of claim 1 comprising at least one thermometer support provided in said tank for removably supporting a thermometer extending into the cooking oil in said reservoir.

4. The deep fat fryer of claim 3 comprising an exhaust deflector provided on said tank at said exhaust opening for deflecting the products of combustion from said gas burner away from said tank and said housing.

5. The deep fat fryer of claim 1 comprising a basket mount provided on said tank for supporting a cooking basket over the cooking oil in said reservoir.

6. The deep fat fryer of claim 5 comprising an exhaust deflector provided on said tank at said exhaust opening for deflecting the products of combustion from said gas burner away from said tank and said housing.

7. The deep fat fryer of claim 6 comprising at least one thermometer support provided in said tank for removably supporting a thermometer extending into the cooking oil in said reservoir.

8. The deep fat fryer of claim 1 comprising at least two basket support rods extending in spaced-apart relationship with respect to each other in said reservoir for supporting a cooking basket in the cooking oil in said reservoir.

9. The deep fat fryer of claim 8 comprising an exhaust deflector provided on said tank at said exhaust opening for deflecting the products of combustion from said gas burner away from said tank and said housing.

10. The deep fat fryer of claim 9 comprising at least one thermometer support for removably supporting a thermometer extending into the cooking oil in said reservoir.

11. The deep fat fryer of claim 10 comprising a basket mount provided on said tank for selectively supporting the cooking basket over the cooking oil in said reservoir.

12. A deep fat fryer comprising a housing; a tank having a bottom and adapted for seating in said housing and a cooking oil reservoir shaped in said tank for containing cooking oil; a burner chamber shaped in said tank adjacent to said cooking oil reservoir; a gas burner disposed in said burner chamber for heating the cooking oil in said cooking oil reservoir; an exhaust opening provided in said tank, said exhaust opening communicating with said burner chamber for removing the exhaust gases produced by said gas burner from said tank; and a reverse-curve baffle provided in said tank, said reverse-curve baffle extending from said exhaust opening in said tank and reverse-curving downwardly to said bottom of said tank, for separating said cooking oil reservoir and said burner chamber in said tank.

13. The deep fat fryer of claim 12 comprising an exhaust deflector provided on said tank at said exhaust opening for deflecting the exhaust gases from said gas burner away from said tank and said housing.

14. The deep fat fryer of claim 12 comprising at least one thermometer support provided in said tank for removably supporting a thermometer extending into the cooking oil in said cooking oil reservoir.

15. The deep fat fryer of claim 12 comprising a support for supporting said tank and said housing.

16. The deep fat fryer of claim 13 comprising:
(a) at least one thermometer support provided in said tank for removably supporting a thermometer extending into the cooking oil in said cooking oil reservoir; and
(b) a support for supporting said tank and said housing.

17. The deep fat fryer of claim 13 comprising at least two basket support rods extending in spaced-apart relationship with respect to each other from said reverse-curve baffle and said tank in said cooking oil reservoir for supporting a cooking basket in the cooking oil in said cooking oil reservoir.

18. The deep fat fryer of claim 17 comprising:
(a) at least one thermometer support provided in said tank for removably supporting a thermometer extending into the cooking oil in said cooking oil reservoir;
(b) a basket mount provided on said tank for selectively supporting a cooking basket over the cooking oil in said cooking oil reservoir; and
(c) a support for supporting said tank and said housing.

19. A deep fat fryer comprising a housing having an open top; a tank having a tank bottom and adapted for seating in said housing through said open top and a cooking oil reservoir shaped in said tank for containing cooking oil; a burner chamber shaped in said tank adjacent to said cooking oil reservoir; a gas burner disposed in said burner chamber for heating the cooking oil in said cooking oil reservoir; an exhaust opening provided in said tank, said exhaust opening communicating with said burner chamber for exhausting the exhaust gases produced by said gas burner from said tank; and a reverse-curve baffle provided in said tank, said reverse-curve baffle reverse curving downwardly from said exhaust opening to said tank bottom of said tank, for separating said cooking oil reservoir and said burner chamber in said tank.

20. The deep fat fryer of claim 19 comprising:
(a) at least one thermometer support provided in said tank for removably supporting a thermometer extending into the cooking oil in said reservoir;
(b) a basket mount provided on said tank for selectively supporting a cooking basket over the cooking oil in said reservoir; and
(c) a support for supporting said tank and said housing.
